(19) United States
(12) Patent Application Publication
(10) Pub. No.: US 2011/0208770 A1
(43) Pub. Date: Aug. 25, 2011

(54) AUTOMATED CONFLICT OF INTEREST REPORTING METHODS AND APPARATUS

(76) Inventor: James H. Snider, Severna Park, MD (US)

(21) Appl. No.: 12/711,503

(22) Filed: Feb. 24, 2010

(51) Int. Cl. G06F 17/30

(52) U.S. Cl. 707/769; 707/705; 707/E17.014

(57) ABSTRACT

Computer-implemented architectures and interfaces for automated conflict of interest reporting using a bias ontology are described. In a covered action search, potential conflicts of interest are identified by associating one or more covered interests for an agent with one or more covered actions performed by the agent on behalf of a principal. A bias report representing the potential conflicts of interest may be displayed to a user reading a covered document or transmitted to a user in a separate notification. Multiple user interfaces for generating a query used to perform a semantic search for data stored according to a bias ontology are also described.

### BACKGROUND

The economic growth and general progress of modem civilization has partly depended on an increasing division of labor. For example, the British economist Adam Smith observed as early as the late eighteenth century, the beginning of the Industrial Revolution, that when many specialized laborers manufacture a pin, pin production is more efficient than when a single individual manufactures each pin from start to finish.

At one extreme are hunter-gatherer societies, where there is minimal specialization—indeed, not even the most basic specialization between those who produce and consume food. At the other extreme is modern society, where there are tens of thousands of distinct occupational roles—and more and more specialized tasks with every passing year.

Economists often describe the relationship between the purchaser of a specialized task and the provider of the specialized task as a principal-agent (or “agency”) relationship. The person who purchases the specialized task is referred to as a principal and the person who provides the task is referred to as an agent. Defining principal-agent relationships in this manner allows economists to describe problems associated with the division of labor in an abstract and thus universal way. Instead of conducting separate studies of occupation X, occupation Y, or occupation Z, economists can use the abstract language of principal-agent theory to analyze the common economic characteristics of all those occupations.

Economists also often distinguish between search, experience, and credibility goods to facilitate the analysis of different types of principal-agent relationships. A search good is one where buyer-principals can evaluate the value of the good prior to purchase. An example would be prices in different retail stores for an identical product. Based on the price, the principal may also know the value of the product, assuming the retail stores are otherwise identical.

An experience good is one where principals can evaluate the value of a good after purchase. An example might be purchasing a cellular phone to work on a particular wireless network in a particular set of locations. Although it may be difficult for a principal to know the quality of reception the cell phone will provide at the particular set of locations prior to purchasing the phone, the principal may be able to gauge the quality of reception in the particular set of locations after the phone has been purchased and used at the particular set of locations.

A credibility good is one where a principal has difficulty evaluating the value of a good even after purchase and use. An example would be the choice made by a doctor to recommend a prescription for a particular medical ailment. Many patients lack the expertise to evaluate the recommendation of the doctor, even after the patient has followed the recommendation provided by the doctor. Accordingly, agency relationships involving credibility goods are different than agency relationships involving search or experience goods insofar as principals rely on trusting agents more than when the agents provide search or experience goods. That is, with credibility goods, principals cannot readily evaluate the output of agents, so they place greater emphasis on inputs, most notably an agent's interests and expertise. If a principal determines that the interests of an agent are aligned with the interests of the principal and that the agent has sufficient expertise, then the principal may be more willing to delegate a task to an agent even though the principal cannot easily evaluate the output of the agent's work.

Given the reliance on inputs rather than outputs in the evaluation of credibility goods, the standard of evidence to assess a conflict of interest is often an appearance rather than actual conflict-of-interest standard. That is, no evidence of a causal link between an agent's conflict of interest and action needs to be provided. The existence of the conflict of interest is grounds itself for mistrust of the agent's action.

Over the last few hundred years, principal-agent relationships involving the transaction of credibility goods have become increasingly important. As a result, principals have been increasingly forced to make decisions about delegation by factoring in an assessment of an agent's interests and expertise. Symptomatic of this change in economic relationships was the explosion of government mandated occupational licensing during the twentieth century. In 2003, the Council of State Governments estimated that at least one state licensed more than 800 occupations and more than 1,100 occupations were licensed, certified, or registered. According to a 2008 report issued by the National Bureau of Economic statistics, 29 percent of the U.S. workforce in 2006 was required to hold an occupational license from a local, state, or federal government agency. In addition, another 6% of the workforce worked in a government certified occupation. In a licensed occupation, the activity of the occupation is regulated, and in a certified occupation, the use of the occupation's label is regulated. As the economy has shifted from agriculture and manufacturing to services, the percentage of workers in a licensed occupation has been growing, increasing six fold from the 1950s to the 2000s.

Government issued occupational licenses typically mandate that the licensee possess a minimum degree of expertise by acquiring some type of credential. The licenses may also mandate that the licensee follow a professional code of conduct. Real estate brokers, for example, often have a legal obligation to represent the interests of their clients and disclose to their clients any conflicts of interest that might interfere with such representation.

In addition to licensing, the government regulates many actions to prevent fraud in the presentation of an agent's credentials and interests. The U.S. Federal Trade Commission, for example, mandates that many types of endorsers, including unlicensed bloggers, disclose on their blogs material conflicts of interest when they review a product.

In addition to government regulation concerning agent credentials and interests, the private sector has developed many institutions and procedures to foster trust in agency relationships. For example, many trade associations that are collections of agents have codes of conduct concerning the disclosure of conflicts of interests to principals that they expect their agent members to follow as a condition of membership. Similarly, many formal written contractual agreements between principals and agents include provisions concerning conflicts of interest and expertise.

Often the claim of an agent to represent a principal (an “agency claim”) may be more informal—backed neither by government mandate nor formal written contract signed by both the principal and agent. For example, many newspapers, magazines, newsletters, TV broadcasters, and bloggers claim to their audiences that they provide independent and thus objective information.

Additionally, many claims about agency relationships are made by third parties. For example, many non-profit and for-profit media outlets routinely comment on the claimed independence and objectivity of agents. It is a common practice in political reporting, for example, to “follow the money” and try to link the campaign contributions of special interests to the votes and other actions of elected officials. Similarly, many competitors and independent critics devote great resources to trying to disclose the undisclosed conflicts of interest that a particular media outlet may have in covering a particular story.

### SUMMARY

Agency relationships are widespread as are attempts to provide principals with more efficient access to information about the expertise and interests of agents. However, the Applicant has recognized that conventional solutions for capturing conflict of interest information in agency relationships are ad hoc, and vary from industry-to-industry, occupation-to-occupation, and company-to-company. Laws regarding the disclosure of conflicts of interest by occupational licensees, for example, have often been developed as a result of concrete, well-publicized problems. The resulting laws are typically narrowly drafted, embedded in many different and often obscure sections of legal code, and are interpreted and administered by different, occupation- or industry-specific agencies. Non-government agency claims have also been made in a similar manner.

The above-described advantages that economists find in using a standardized terminology to describe principal-agent relationships have not been extended to government mandated and voluntarily entered contracts between principals and agents. In particular, despite the rise of the Internet in the past two decades and the recent development of semantic web technologies, there has been no practical, universal, and machine-readable language to describe principal-agent relationships. That is, no interface architecture has been developed to embrace the universal logic of agency claims in order to realize economies of scale and automate the disclosure of conflicts of interest across agency relationships.

Some embodiments of the present invention are directed to an interface for using a universal, machine-readable bias ontology to disclose and access agency claims involving independence; that is, an agent not having conflicts of interest with a principal. Accordingly, some embodiments are directed to an application architecture associated with the use of such an interface. An advantage of analyzing principal-agent conflicts of interest in this manner is that hierarchical principal-agent relationships may be more easily identified and processed.

Some embodiments are directed to a method of identifying one or more conflicts of interest between a principal and an agent. The method comprises determining that the agent has performed a covered action on behalf of the principal; associating, with at least one processor, at least one covered interest for the agent with the covered action; and outputting an alert that the at least one covered interest represents a potential conflict of interest between the principal and the agent.

Some embodiments are directed to a method of identifying one or more potential conflicts of interest between a principal and an agent. The method comprises receiving at least one query to identify the one or more potential conflicts of interest; aggregating, with at least one processor, information from a plurality of data sets based, at least in part, on information in the at least one query and metadata associated with the information in the plurality of data sets; and outputting an indication of the aggregated information, wherein the indication represents the one or more potential conflicts of interest between the principal and the agent.

Some embodiments are directed to a computer-readable storage medium encoded with a plurality of instructions that, when executed by a computer, perform a method. The method comprises determining that the agent has performed a covered action on behalf of the principal; associating, with at least one processor, at least one covered interest for the agent with the covered action; and outputting an alert that the at least one covered interest represents a potential conflict of interest between the principal and the agent.

Some embodiments are directed to a computer system comprising at least one processor. The at least one processor is programmed to receive at least one query to identify the one or more potential conflicts of interest; aggregate, with at least one processor, information from a plurality of data sets based, at least in part, on information in the at least one query and metadata associated with the information in the plurality of data sets; and output an indication of the aggregated information, wherein the indication represents the one or more potential conflicts of interest between the principal and the agent.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is flowchart of a technique for performing a covered action search in accordance with some embodiments of the invention;

FIG. 2 is a flowchart of a technique for providing an in-document alert in accordance with some embodiments of the invention;

FIG. 3 is a flowchart of a technique for identifying conflicts of interest in accordance with some embodiments of the invention;

FIG. 4 is a flowchart of a technique for performing a semantic search using a bias ontology in accordance with some embodiments of the invention;

FIG. 5 illustrates a portion of a user interface for specifying a query using a Boolean search interface in accordance with some embodiments of the invention;

FIG. 6 illustrates a portion of a user interface for selecting an agency relationship using a faceted search interface in accordance with some embodiments of the invention;

FIG. 7 illustrates a portion of a user interface for selecting a covered action using a faceted search interface in accordance with some embodiments of the invention;

FIG. 8 illustrates a portion of a user interface for selecting a date range for covered action(s) in accordance with some embodiments of the invention;

FIG. 9 illustrates a portion of a user interface for selecting a covered interest using a faceted search interface in accordance with some embodiments of the invention;

FIG. 10 illustrates a portion of a user interface for selecting a date range for covered interests(s) in accordance with some embodiments of the invention;

FIG. 11 illustrates a portion of a user interface for selecting preferences for future alerts in accordance with some embodiments of the invention;

FIGS. 12A and 12B illustrates portions of a decision tree user interface in accordance with some embodiments of the invention;

FIG. 13 schematically illustrates hierarchical relationships between multiple principals and multiple agents that may be searched and identified by some embodiments of the invention;

FIG. 14 illustrates an exemplary computer system on which some embodiments of the invention may be implemented; and

FIG. 15 illustrates an exemplary networked computer system having components that may be used by some embodiments of the invention to provide automated conflict of interest searching and/or reporting.

### DETAILED DESCRIPTION

An abstract, machine-readable conflict of interest data structure may result in efficiently collecting and utilizing conflict of interest data, just as XBRL, a widely adopted ontology to describe financial data, has facilitated the collection and utilization of financial data. Accordingly, some embodiments of the invention are directed to methods and apparatus for using a data structure to identify conflicts of interest in agency relationships (a “bias ontology”).

Although embodiments of the invention may be used in combination with any suitable data structure designed to describe a bias ontology, an exemplary bias ontology for use with some embodiments of the invention describes structured, machine-readable conflict of interest relationships in an abstract way rather than with reference to particular principals and agents. For example, particular types of agency relationships such as voters and an elected official, patients and a doctor, or readers and a blogger may be defined in a bias ontology using a generic dyadic principal-agent relationship as the basic conflict of interest unit in the bias ontology. Defining agency relationships in such an abstract manner may facilitate agency conflict of interest deductions and computations, such as the automatic nesting and inheritance of principal-agent relationships such as voters delegating tasks to an elected representative who then delegates some of those tasks to appointed commissioners. A more detailed description of an exemplary bias ontology for use with some embodiments of the invention is described in more detail below.

A widely adopted bias ontology may lead to great economies of scale and innovation in bias applications: economies of scale because the market for bias applications may cut across industries and thus be larger; innovation because the separation of conflict of interest data collection from applications that use that data may lead to more competition among application developers.

However, even if a particular bias ontology is not widely adopted, bias applications may still benefit from the universal logic underlying principal-agent relationships, including the importance of identifying principals and agents, nested relationships between principals and interests, an agent's covered interests, and an agent's covered actions; and then mapping an agent's covered interests onto its covered actions, using a principal-agent data structure to simplify searches for potential bias, and balancing a principal's interest in disclosure with an agent's interest in protecting trade secrets through the utilization of a trusted bias auditor.

By analyzing principal-agent conflicts of interest in this manner, hierarchical principal-agent relationships may be more easily identified and processed. For example, consider a voter that has elected an official who has appointed another official to a commission. The commissioner may inherit conflicts of interest from the officials who appointed him as well as have his own conflicts of interest. To capture these complexities, the specification of an agency relationship may have a hierarchical map of all of the principal-agent relationships linked to it, and a user may be able to search on the core principal-agent relationships or include one or more linked principal agent relationships. Continuing with the example above, a user may limit the search to only the covered interests and actions of the appointed commissioner. Alternatively, the user may add the secondary agency relationship between the voters and the elected official who appointed the commissioner resulting in a richer set of potential conflicts of interest.

Bias application architectures in accordance with some embodiments of the invention may include a covered action search interface and/or a semantic search interface. In some instances, a covered action search may be viewed as a semantic search where most of the search parameters are either predetermined based on the nature of the covered action or set to default values for a particular type of covered action as described in more detail below.

As defined herein, a covered action is a formal action an agent takes on behalf of a principal. For example, covered actions include a blogger-agent reviewing a product, a doctor-agent prescribing a drug, or a legislator-agent requesting an earmark. In a covered action search, one or more covered interests may be automatically linked to a particular covered action. As defined herein, a covered interest is a financial or nepotistic interest of an agent that might pose a material conflict of interest with a covered action performed by the agent.

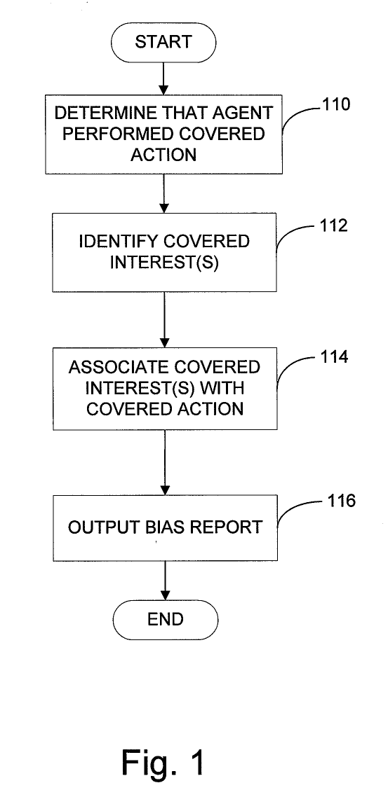

An example of a covered action search in accordance with some embodiments of the invention is illustrated in FIG. 1. In act 110, it may be determined that an agent performed a covered action. This determination may be made in any suitable way and embodiments of the invention are not limited in this respect. For example, each time that a blogger-agent posts a review of a product to the web, a notification of this post may be transmitted to one or more computers connected to the web, and a bias check to search for potential conflicts of interest involving the blogger and the product may automatically be initiated in response to receiving the notification of the post. Alternatively, a user of a computer may initiate a bias check upon determining that an agent has performed a covered action. For example, a patient who has been prescribed a pharmaceutical product by a doctor may want to know if the doctor has any conflicts of interest with the manufacturer of the pharmaceutical product. The patient becomes aware of the covered action when the pharmaceutical product is prescribed. The covered action of prescribing may then trigger an automatic bias check to generate a bias report involving the doctor and the pharmaceutical company. Alternatively, the patient may customize a bias check using one or more search interfaces described in more detail below

After it has been determined that a covered action has been performed by an agent, in act 112, one or more covered interests of the agent are identified. For example, each product a blogger reviews may be automatically linked to the blogger's covered interests, including funds the blogger has received from the manufacturer of the product's agents; every prescription a doctor makes may be automatically linked to the doctor's covered interests, including funds the doctor has received from agents of the manufacturer of the prescribed pharmaceutical product; and every earmark a legislator requests may be automatically linked to the legislator's covered interests, including funds the legislator has received from the recipient of the earmark's agents.

Covered interests may be identified in any suitable way and embodiments of the invention are not limited in this respect. For example, in a reporting system that employs a bias ontology that incorporates semantic web technologies, metadata or “tags” describing a particular principal-agent relationship may be associated with covered interest information stored in one or more data sets associated with a networked computer. When a bias check is initiated for a particular covered action, covered interests for the agent with responsibility for the covered action may be identified by searching the network for metadata identifying the agent that is associated with covered interest information.

For example, trade organizations may have ethics codes requiring their members to disclose conflicts of interest to customers. Additionally government agencies also mandate that dozens of occupations, including financial advisors, doctors, and real estate brokers, and more recently, bloggers, disclose conflicts of interest to their customers. This information may be stored in network-connected databases that may be searched in accordance with some embodiments of the invention. Adopting a bias ontology that requires information about covered actions and covered interests to be “labeled” with identifying information about agency relationships may facilitate identifying covered interests in response to a bias check. That is, in some instances, a single query, whether automatically or manually initiated, may result in complex searches of multiple network-accessible data sets in an attempt to identify every covered interest for an agent associated with a covered action.

After the covered interests of the agent have been identified in act 112 in response to a bias check, the covered interests are associated with the covered action in act 114. The association between an agent's covered interests and a covered action may be made in any suitable way and embodiments of the invention are not limited in this respect. For example, metadata associated with a covered action may be updated to indicate that one or more covered interests of an agent are associated with the covered action. Alternatively, information associating one or more covered interests and the covered action may be stored separately from the covered action (e.g., a blogger's post) and the separately stored linkage between the covered interest and the covered action may be referenced when displaying the covered action, as discussed in further detail below.

In accordance with some embodiments, the association between an agent's covered interests and the agent's covered actions may be facilitated by using an ID ontology. For example, a blogger may receive something of value from a manufacturer and the blogger may review one of the manufacturer's models. An ID ontology may be used to link the manufacturer to the brand and the model number reviewed by the blogger. In one implementation, an ID ontology may link corporate subsidiaries identified in an SEC filing with registered trademark/brand names and model identifiers (e.g., UPC codes that link manufacturers with model numbers). It should be appreciated, however, that some embodiments may not use an ID ontology, and associations between an agent's covered interests and the agent's covered actions may be made in some other way. For example, an agent may manually insert interests into a covered document or an agency claim may include default interests to be associated with a covered action. Each of these alternative techniques for associating covered interests and covered actions are described in further detail below.

After associating the covered interests of an agent with a covered action, a bias report identifying the potential conflicts of interests as represented by the associated covered interests for the particular covered action may be output in act 116. The bias report may be provided in any suitable manner including, but not limited to, an out-of-document or an in-document alert, as described in further detail below.

In some embodiments, the results of a bias check (also called a bias report or an alert) may be provided to a user in accordance with one or more configuration parameters specified by a user. A first type of bias report, called an “out-of-document” alert, may be sent to a computing device of a user over a wired or wireless network such as via an RSS feed, email, text message, or instant message. The alert may be sent to the user instantly in response to detecting the occurrence of a covered action, although users may additionally or alternatively specify alerts be output at a particular time or at designated time intervals including, but not limited to, daily or weekly. A computing device of a user may also include an interface for configuring the types of bias reports that the user wants to receive. For example, the user may only want to receive bias reports related to a small subset of covered actions or only receive bias reports for covered actions of one or more agents.

For example, a local reporter might be interested in tracking an elected official's appointments to commissions. A medium size city may have dozens of commissions, each made up of multiple commissioners. In accordance with some embodiments, the reporter may select one or more configuration parameters so that each time the elected official makes an official appointment (a type of covered action) the reporter will receive an email notification if the covered interests of the elected official include any payments from an appointee.

An advantage of tracking information about agency relationships in this manner is that linkages between covered interests and covered actions that only become evident over time may be captured. In many cases, a potential material conflict of interest may not be evident when a covered action is performed. For example, a builder may make a campaign contribution after an elected official grants him a building permit, or a manufacturer may pay a blogger after the blogger reviews the manufacturer's product. In some embodiments of the invention, bias reports relating to these potential material conflicts of interest may be automatically sent to a user as the data regarding the agency relationship becomes available.

In contrast to an out-of-document alert, which is provided to a user in a separate notification from the document(s) related to the covered action, an in-document alert is a bias report embedded in a covered document codifying a covered action of an agent. Additionally, in some embodiments, in-document alerts may be based on the information available when the document is read, which could be days, weeks, or years after the covered action was performed.

For in-document alerts, when a beneficiary in the covered document is linked to a covered interest, the potential conflict-of interest may be identified in the document. For example, the name of the beneficiary may be highlighted within the text of the document. As with out-of-document alerts, a user may be given control over how in-document alerts appear in the document. For example, when a blogger reviews a product, a reader of the blog may not consider a gift of less than $25 from the manufacturer of the product to the blogger to be a material conflict of interest and therefore may not want such potential conflicts of interest to be indicated in the document. However, another reader of the blog may consider any gift from a manufacturer of a reviewed product to be a material conflict of interest, regardless of value, and the reader may want all such potential conflicts of interests indicated in the document. Potential conflicts of interest may be identified in the document in any suitable way including, but not limited to, using distinctive highlighting, underlining, colors, popups, or footnote marks. Alternatively, in-document alerts may be summarized within a portion of the document such as in a box at the top, side, or bottom of the document. It should be appreciated from the foregoing that any suitable in-document indication may be used and embodiments of the invention are not limited in this respect.

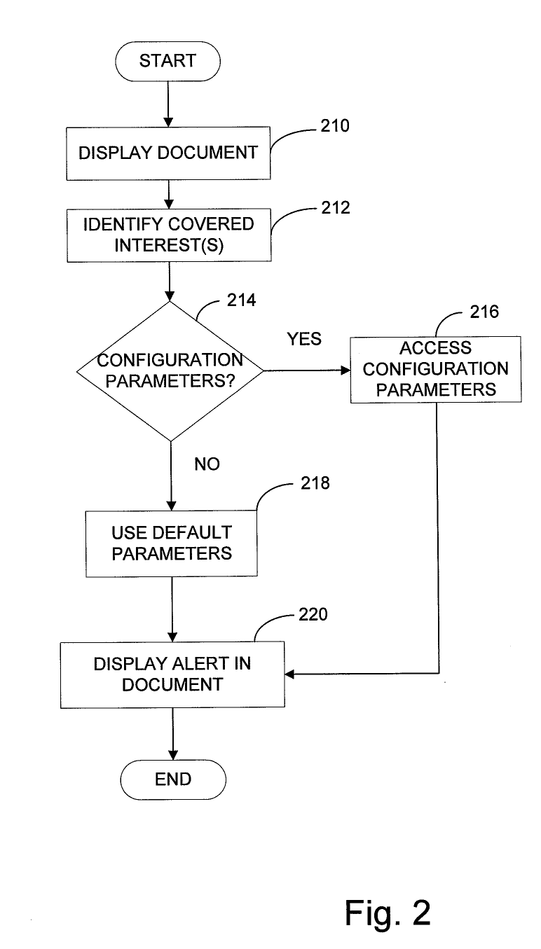

An exemplary technique for providing in-document alerts is illustrated in FIG. 2. In act 210, a covered document associated with a covered action is displayed to a user. For example, a user may use a web browser to navigate to a blog reviewing a particular product. In act 212, covered interests associated with the covered document are identified in accordance with one or more techniques previously described above. For example, a bias check may be initiated and a network (e.g., the Internet) may be searched to identify the covered interests associated with the author of the blog and related to the product that is being reviewed. After the covered interests have been identified, it may be determined in act 214 whether the user has specified configuration parameters including preferences for displaying the potential conflicts of interest in the document.

In one implementation in which the covered document is displayed to the user in a web browser, a browser plug-in application may be provided to manage conflict of interest reporting and a user may select display preferences associated with the plug-in application. In such an implementation, the plug-in may work “behind-the-scenes” to automatically identify covered interests each time that a user navigates to a web page that relates to a covered action and display the in-document alerts in accordance with stored configuration parameters. In other implementations, the conflict of interest reporting may be managed by a separate application executing on the user's computer and embodiments of the invention are not limited in this respect.

If it is determined in act 214 that configuration parameters exist (e.g., as display preferences associated with a browser plug-in application), the configuration parameters are accessed in act 216 and the in-document alert(s) are displayed in accordance with the configuration parameters in act 220. If it is determined in act 214 that particular configuration parameters do not exist, a default set of display parameters may be accessed in act 218, and the conflict of interest information may be displayed in act 220 in accordance with the default parameters.

An advantage of searching for potential conflicts of interest using a bias ontology as described above is that the universe of potential conflicts of interest may be tightly constrained based on agency relationships and linked to a specific covered action or set of covered actions.

In conventional disclosure systems where covered interests and covered actions are not automatically associated, covered interests and covered actions are typically searched separately, forcing searchers to wade through many irrelevant covered interests and sometimes leading to a Hobson's choice between (1) publicly displaying all potential conflicts of interests and thus potentially revealing a private company's trade secrets and (2) protecting trade secrets at the expense of allowing hidden bias. The Applicant has recognized that using a bias ontology that automatically links covered interests and covered actions enables some conflict of interest data to be made public contingent on the existence of a covered action within the control of the agent. Accordingly, entities (e.g., private companies) may be more inclined to disclose all potential conflict of interest information using the bias ontology to promote transparency without the fear that the company's trade secrets will be compromised.

In some embodiments, a third party auditor and reporter of covered interests and actions may determine which covered interests and covered actions should be made public to prevent the disclosure of trade secrets or legally protected free speech rights. Like an auditor of internal corporate financial records, the third party may have access to all internal data relating to covered interests and actions. However, the third party may selectively make information public via covered actions based on relationships between the covered interests and actions specified in an agency claim.

In some situations, all potential covered interests may be made public, as is generally the case with government information. For example, there is often a presumption that the general public has a right to know how taxpayer money is used and that outside income to elected officials, especially relating to political campaigns, should be made public. In the private sector, in contrast, there is generally a presumption that detailed financial information about internal operations should be kept as a trade secret. However, the large amount of financial information that public companies are required to publicly disclose to, for example, the U.S. Securities & Exchange Commission and other government agencies, indicates limits on the presumption that such financial information is proprietary. Situations in which some, but perhaps not all covered interests are expected to be made public include, but are not limited to, public utilities, contractors paid with public funds, and nonprofits heavily subsidized with taxpayer money as a result of the tax deduction for charitable giving. In situations where covered interests must be publicly disclosed and the preservation of trade secrets or the infringement of speech rights are not issues, a third party auditor may still be useful to verify the accuracy of the disclosures.

As described above, when data published to the web include metadata related to the content of the data (e.g., as tags in a bias ontology), the data can be aggregated and searched more efficiently. Semantic web technologies, including a data structure configured in accordance with a bias ontology, an example of which is described in further detail below, may be structured to take advantage of such metadata to facilitate conflict of interest searching and/or reporting.

Increased search efficiency may result from a combination of automated data aggregation and searching. Data relevant to a particular ontology may be scattered among many different databases published to the web. For example, consider the data sets relevant to identifying an elected official's covered interests and actions. Data for the elected official's covered interests may be stored among multiple distributed databases that include information for items such as campaign contributions, lobbying, gifts, and personal assets. Altogether separate databases may store information for the official's covered actions, such as government budgets, laws, appointments, and contracts. In conventional conflict of interest reporting, all this information would typically have to be individually searched for and aggregated by, for example, manually entering all of the information into a single, searchable database. However, some embodiments of the invention are directed to improving conflict of interest reporting by automating the aggregation of covered interest and covered action information.

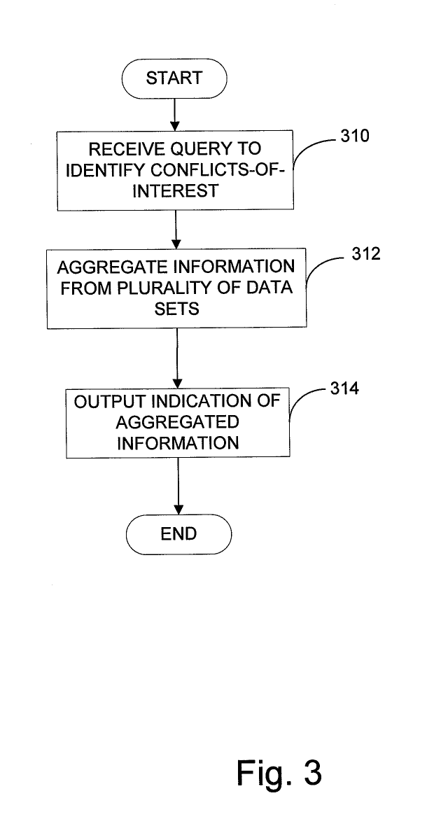

FIG. 3 illustrates a technique for identifying one or more potential conflicts of interest in an agency relationship by aggregating information from a plurality of data sets in accordance with some embodiments of the invention. In act 310, a query to identify one or more conflicts of interest is received by, for example, a processor of a computer on which some embodiments of the invention may be performed. As described in more detail below, a user may interact with one or more user interfaces on a computer to construct the query by specifying information related to an agency claim on which the user would like to search. The specified information in the query may include, but is not limited to, an identifier for a principal, an identifier for an agent, one or more covered actions, and one or more covered interests.

After receiving the query in act 310, information from a plurality of data sets is aggregated in act 312 by performing a bias check to associate covered interests and covered actions in accordance with the information specified in the received query. In some embodiments, the aggregation may be performed “behind-the-scenes” rather than in response to any one particular query. For example, as new disclosure data becomes available on the network, an aggregating component implemented using software, hardware, or some combination thereof, may automatically execute one or more bias checks to attempt to link the new disclosure data to existing disclosure data. Aggregation may be performed in any suitable way, and embodiments of the invention are not limited in this respect. For example, information linking covered interests and covered actions for agents and principals uniquely identified using an ID ontology may be stored in one or more aggregation databases accessible to a semantic search engine (e.g., a processor) configured to perform one or more conflict of interest searches. Alternatively, aggregation may comprise adding and/or modifying metadata associated with disclosure data accessible on a network to indicate one or more agency relationships associated with the disclosure data. In turn, a semantic search engine may use the associated metadata to facilitate a search for potential conflicts of interest related to information specified in a received query.

In act 314, an indication of the aggregated information as a result of bias checking may be output to a user. For example, aggregated information identified during the search may be displayed to the user or transmitted to the user in some other form such as in a data file, an email, a text message, etc. In some embodiments, one or more parameters of the initial query may be modified and a new semantic search may be executed using the new parameters.

The Applicant has recognized that although aggregation of data from multiple distributed data sets on its own may be helpful in identifying conflicts of interest, aggregation does not clarify how the data are related. By contrast, an ontology can fit the various pieces of data together into a logical whole. With a bias ontology, if the principal-agent relationship is known and carefully specified in an agency claim, then the potential covered interests and actions may be automatically inferred and searched using a relatively simple query.

For example, consider linking campaign contributions for a mayor of a big city and gifts the mayor receives to the city government budget. The budget may be built upon, for example, one million transactions with various vendors and there may be thousands of sources of contributions and gifts. In conventional systems, the budget detail may only be published in paper form or perhaps electronically in an unstructured document format such as portable document format (pdf), and the gift and campaign contributions may be stored in separate, well-structured relational databases. To identify associations between the contributions/gifts and the budget items using the unstructured format for the budget, a user would have to inspect each line of the city's one million financial transactions and then, one-by-one, look for matches in the campaign contribution and gift disclosure databases. The Applicant has appreciated however that, if the data were entered and made accessible via a network with a bias ontology, a simple query in accordance with some embodiments of the invention may automate these millions of labor intensive searches using semantic web technologies to provide search results for improved conflict of interest searching and/or reporting.

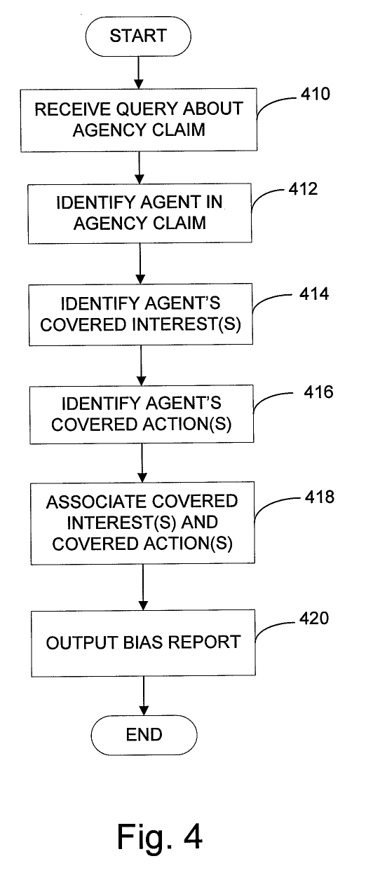

An example of a technique for performing a semantic search within a bias ontology framework in accordance with some embodiments of the invention is illustrated in FIG. 4. In act 410, a query including information about one or more components of an agency claim (e.g., principal, agent, covered action, covered interest) is received by, for example, a semantic search engine (e.g., a processor of a computer configured to perform semantic searching). If not explicitly defined in the query, in act 412 the agent associated with the agency claim is identified. Some bias ontologies, including the exemplary bias ontology described below, may include an ID ontology that uniquely identifies each agent in the bias ontology. Use of such an ID ontology may facilitate the identification of covered interests and covered actions for a particular agent or group of agents in a semantic search.

In act 414, information about the agent and other information provided in the received query is used to identify one or more covered interests for the agent that may present a potential conflict of interest with one or more covered actions specified in an agency claim. The search for covered interests is facilitated by using a bias ontology due to the standardized machine-readable form in which the principal-agent relationships are described within the bias ontology. Covered interests for the agent may be identified in any suitable way including, but not limited to, locating such information in one or more aggregation databases or by using metadata associated with network-accessible disclosure data stored in one or more local or remotely located data sets, as described above in connection with FIG. 3. If an ID ontology is used, all covered interests associated with an agent's particular identifier may be returned in act 414 in accordance with some embodiments.

After an agent's covered interests have been identified, in act 416 the agent's covered actions may be identified, provided that one or more particular covered actions are not explicitly specified in the initial query. The covered actions for an agent may be identified in any suitable way including, but not limited to, the techniques for identifying the covered interests of an agent as described above. In act 418, the identified covered interests and covered actions for an agent are associated. The association between the covered interests and covered actions may be performed in any suitable way. For example, information linking the covered interests and covered actions for the agent may be stored in one or more data sets accessible to a semantic search engine and/or metadata associated with disclosure data (e.g., financial records) stored in one or more data sets may be added or modified to indicate the link(s) between the covered interests and covered actions. In act 420, the output of the semantic search (e.g., a bias report) is provided to the user. For example, the search results may be displayed to the user or transmitted to the user in some other form such as in a data file, an email, a text message, etc. Furthermore, the bias report may be static or interactive. That is, in some embodiments, a user may be able to interact with the bias report to analyze the output in one or more ways. However, in other embodiments, the bias report may be used as input to an application executing on a computer to perform further analysis (e.g., statistical analysis) on the information in the bias report.

As discussed above, a user may provide information for a semantic search using one or more user interfaces. Exemplary user interfaces for use with some embodiments of the invention are now described. The exemplary user interfaces described below relate to an elected official's agency relationship with the official's constituents. However, it should be appreciated that similar user interfaces may be used in accordance with any type of agency relationship, including, but not limited to bloggers with readers, doctors with patients, and financial advisors with investors. Furthermore, each of the exemplary user interfaces is discussed in the context of the exemplary bias ontology discussed in more detail below, although it should be appreciated that other bias ontologies may alternatively be used.

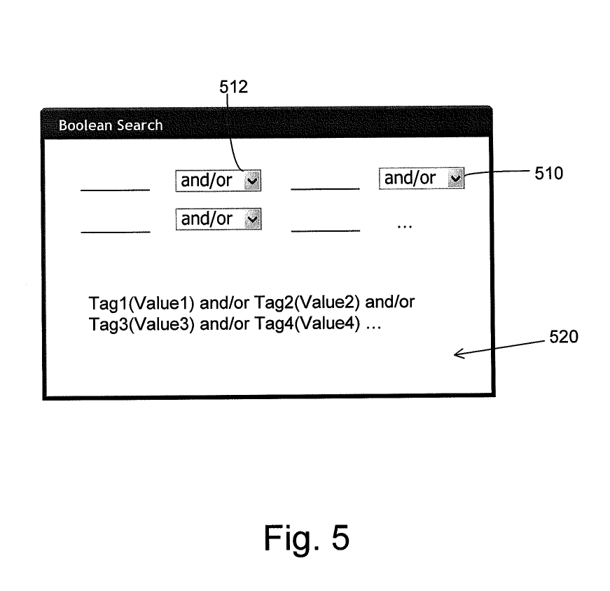

A Boolean search interface in accordance with some embodiments of the invention is illustrated in FIG. 5. The Boolean search interface illustrated in FIG. 5 includes two different techniques by which a Boolean search string may be specified. A first technique 510 enables a user to enter text in fields separated by Boolean logic operators (e.g., and, or, and/or) that may be selected from a list. In the example of FIG. 5, the list of Boolean operators are specified in drop-down menus 512 from which a user may select one of the Boolean operators, however it should be appreciated that the list of Boolean operators may be presented to the user in any suitable way including, but not limited to using radio buttons, checkboxes, and/or any other user interface element.

A second technique 520 may be specific to a particular bias ontology that is used to perform a semantic search. Technique 520 involves specifying tag indicators and tag values for the semantic search in accordance with the particular bias ontology.

For example, suppose a user is interested in determining whether a county executive in Anne Arundel County, Md. had any material conflicts of interest in appointing more than a hundred individuals to public bodies over a four year period. A Boolean search string to perform such a search may be represented as:
AgencyClaims(Anne Arundel County Executive) and
CoveredActions(AppointmentsToPublicBodies) and CoveredActionDates(Jan. 1, 2000 to Jan. 1, 2004) and CoveredInterests(All) and CoveredInterestDates(Jan. 1, 1995 to Present), where the tags AgencyClaims, CoveredActions, CoveredAction Dates, CoveredInterests, and CoveredInterestDates are defined in a bias ontology used to perform the semantic search. Based on the agency claim associated with the county executive as agent to the citizens of Anne Arundel County, such a Boolean search query may trigger tens of thousands of searches to identify potential material conflicts of interest in the County Executive's appointments. The results of such a search may include, for example, a simple list of every appointee, with a list under each name of any covered interests linked to the specific appointment. Alternatively, a more complex bias report may use templates for other reports, including reports with different visualizations and statistical analyses of the correlations between covered interests and appointments.

In another example, suppose a user is interested in determining whether the county executive in Anne Arundel County, Md. had any material conflicts of interest in putting together the County's budget for a particular year. The following Boolean search query may be used to perform such a semantic search for conflicts of interest: AgencyClaims(Anne Arundel County Executive) and CoveredActions(Budget) and CoveredActionDates(Jul. 1, 2009) and CoveredInterests(All) and CoveredInterestDates(Jan. 1, 2000 to Present). An exemplary bias report for such a semantic search may include an interactive report comprising a hierarchically structured programmatic view of the budget, with a red mark on any budget line item linked to a vendor with a covered interest. A programmatic budget view may categorize budgets by program area such as police, fire, and waste removal. For additional program details, the viewer may interact with the output to reveal information from summary categories down to individual transactions with vendors. Alternative report templates include, but are not limited to, object and location views of the budget. An object view may categorize budgets by object categories such as salaries, benefits, supplies, and buildings, whereas a location view may categorize budgets by the physical facilities associated with each budget. In some embodiments, a location view may be rendered on a map (e.g., a physical map of the County) to provide additional information about how budget expenditures linked to covered interests are geographically distributed.

Another type of interface to generate a search query in accordance with some embodiments of the invention is a faceted search interface. In a faceted search interface, it may be assumed, for purposes of facilitating a quick search, that one or more search engines have aggregated relevant bias ontology data for each of the filtered levels in the faceted search interface. For example, in the illustrative faceted search interface described below, the relevant bias ontology data for each elected executive and legislative office in the U.S. and for all covered interests and actions may be aggregated and stored prior to performing a search using the interface. In some embodiments, the one or more search engines may aggregate the bias ontology data “behind-the-scenes” as new data becomes available.

An illustrative faceted search in accordance with some embodiments of the invention involves six filtering steps: (1) agency relationship(s), (2) covered actions, (3) covered action dates, (4) covered interests, (5) covered interest dates, and (6) future alerts. In the example discussed below, each of these filtering steps is provided as a portion of a user interface displayed to a user. However, it should be appreciated that some or all of the filtering steps may be provided by different user interfaces and embodiments of the invention are not limited in this respect. Additionally, it should be appreciated that different embodiments may include different numbers of filtering steps and embodiments of the invention are not limited by the number of included filtering steps.

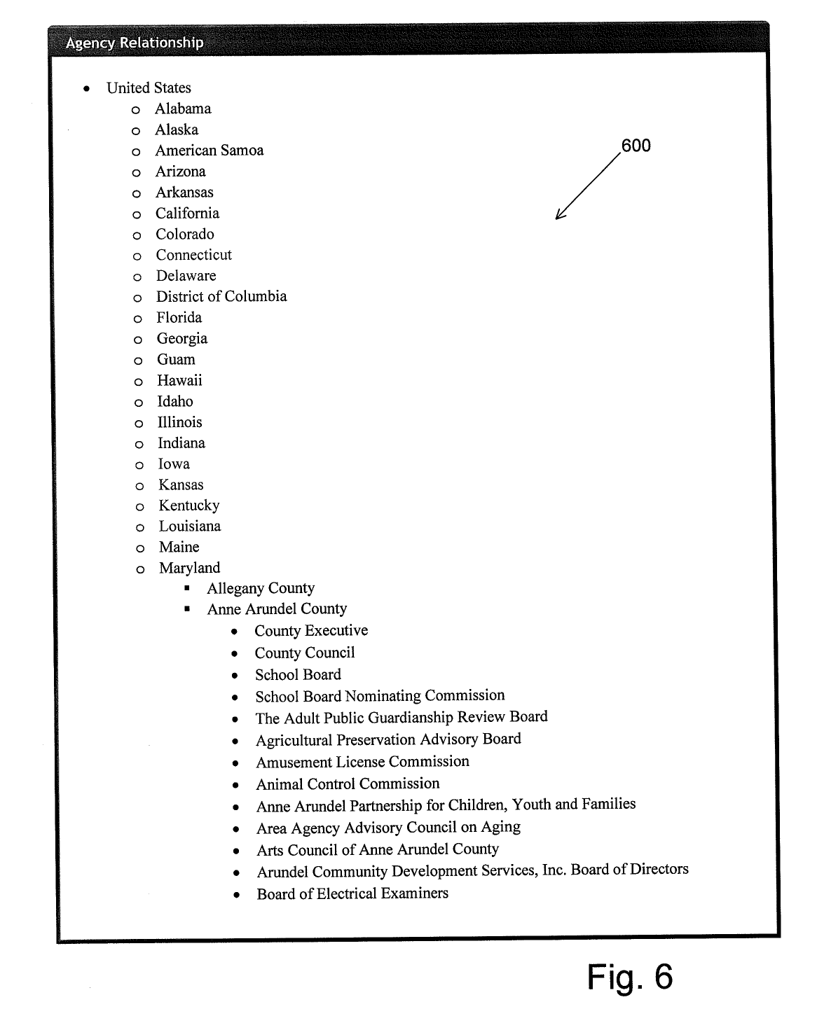

FIG. 6 illustrates an exemplary faceted search interface 600 for selection of an agency relationship. The U.S. has more than 80,000 political jurisdictions covering more than 500,000 elected officials and millions of officials appointed to public bodies. The faceted search interface 600 provides an expandable list for each of these elected and appointed officials. The top level in faceted search interface 600 is for the United States (e.g., other countries may also be included), the next level is for U.S. states, and the next level is for U.S. localities (e.g., counties, districts, etc.). A user may interact with faceted search interface 600 to select an agent on which to perform a semantic search. For example, in the faceted search interface 600 illustrated in FIG. 6, the list of elected and appointed agents has been expanded until the county executive in Anne Arundel County, Md. may be selected by a user.

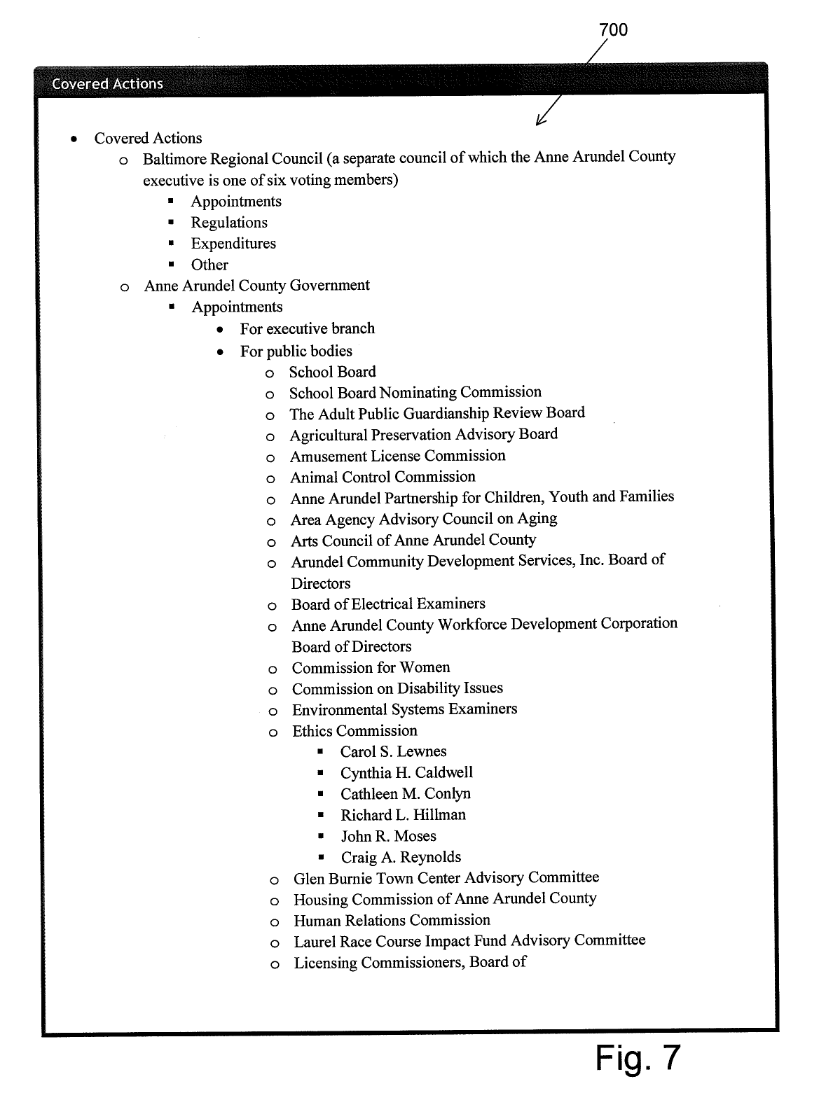

FIG. 7 illustrates an exemplary faceted search interface 700 for selection of a covered action on which to perform a search. Faceted search interface 700 includes an expandable, hierarchical list of covered actions. For example, each entity listed in faceted search interface 700 may have multiple covered actions (e.g., Appointments, Regulations, Expenditures, Other) as indicated in FIG. 7. A user may interact with faceted search interface 700 to select a covered action on which to perform a semantic search. For example, in the faceted search interface 700 illustrated in FIG. 7, the list of covered actions has been expanded until a user may select the covered action related to appointments to the ethics commission in Anne Arundel County (i.e., Anne Arundel County Government: Appointments: Ethics Commission).

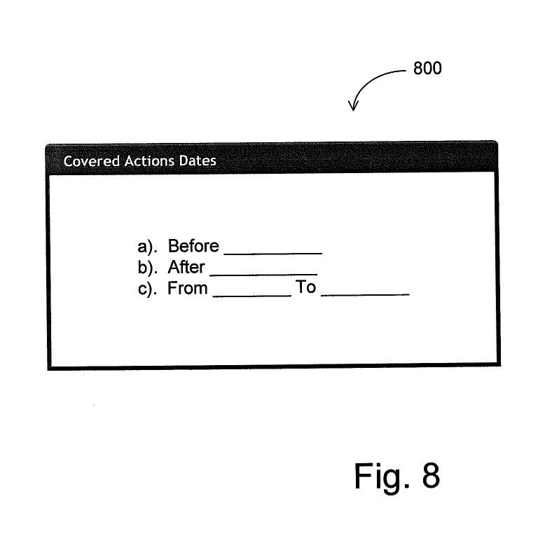

FIG. 8 illustrates an exemplary user interface 800 for specifying a date range for covered actions over which to perform a search. As shown in FIG. 8, user interface 800 may include one or more fields for specifying a start date and/or an end date for performing the search. User interface 800 may also include a field for specifying a date before which the search should be performed and/or a field for specifying a date after which the search should be performed. Although the exemplary user interface 800 includes fields that enable a user to enter text for the date range into the fields, it should be appreciated that any other suitable user interface element for entering a date range may also be used including, but not limited to, selecting a date from an image of a calendar and selecting a date based on one or more drop-down menus, radio buttons, or checkboxes.

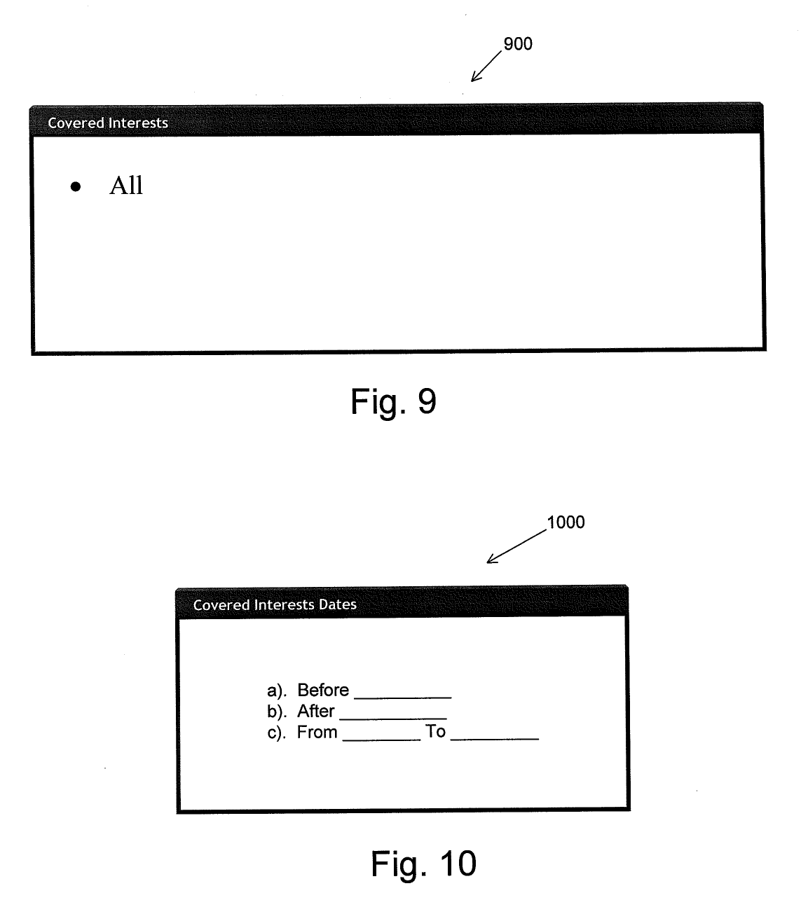

FIG. 9 illustrates an exemplary faceted search interface 900 for specifying covered financial interests on which to perform a search. A faceted search on conflicts of interest, such as a line item budget of a large corporation, can become very complex. In some instances, a user may want to search all covered interests of the agent, including, for example, any information available about the financial interests of the agent's spouse. Accordingly, in some instances, the expandable, hierarchical list of financial interests may have a top level of “All,” as indicated in FIG. 9. Although not shown, the faceted search interface 900 shown in FIG. 9 may include deeper levels to enable a user to configure a search by selecting particular covered interests of an agent.

FIG. 10 illustrates an exemplary user interface 1000 for specifying a date range for covered interests over which to perform a search. As shown in FIG. 10, user interface 1000 may include one or more fields for specifying a start date and/or an end date over which to consider covered interests when performing the search. User interface 1000 may also include a field for specifying a date before which covered interests should be considered and/or a field for specifying a date after which the covered interests should be considered. Although the exemplary user interface 1000 includes fields that enable a user to enter text for the date range into the fields, it should be appreciated that any other suitable user interface element for entering a date range may also be used including, but not limited to, selecting a date from an image of a calendar and selecting a date based on one or more drop-down menus, radio buttons, or checkboxes.

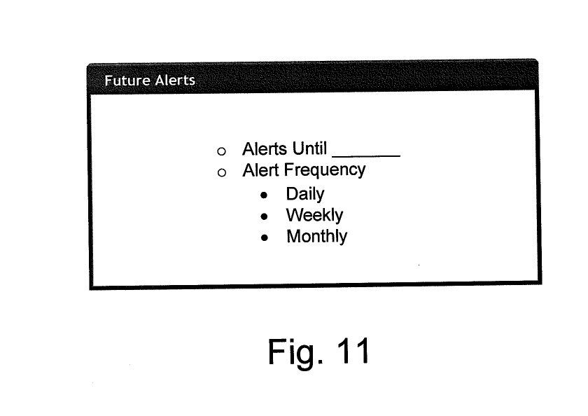

FIG. 11 illustrates an exemplary user interface 1100 for specifying one or more times at which to provide future alerts. Future alerts may be provided to a user when new associations are made between selected covered interests and actions. For example, one or more processors may check on a periodic basis, as indicated by the user's preferences, whether any new conflicts of interest involving selected agency claims exist. As should be appreciated from the foregoing discussion of covered action searches, future alerts may be provided as a type of covered action search that is performed at a specific indicated time and/or at time intervals as specified in user interface 1100.

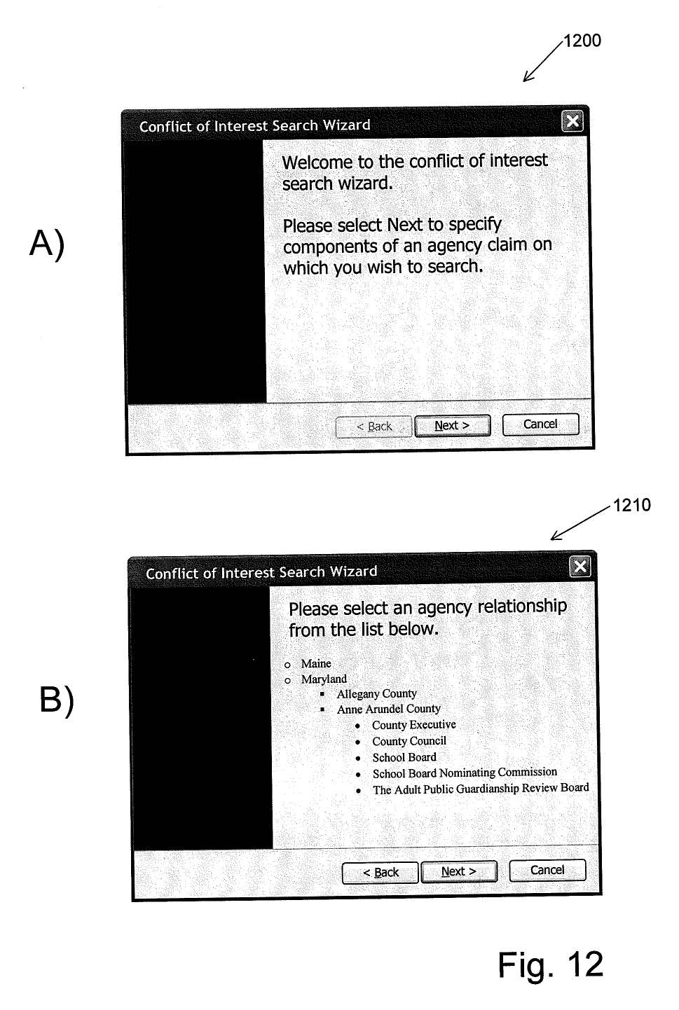

An exemplary decision tree user interface in accordance with some embodiments of the invention is illustrated in FIGS. 12A and 12B. FIG. 12A illustrates a welcome page 1200 of a conflict of interest search wizard. A user may be guided by the search wizard to select components of an agency claim to perform conflict of interest searching. In this way, the search wizard may be considered as a type of user-friendly decision tree in which the search wizard helps a user make decisions by instructing the user which components of the agency claim to specify. For example, a second page 1210 of the search wizard shown in FIG. 12B may instruct the user to select an agency relationship from one or more displayed choices. In the example of FIG. 12, the user may select an agency relationship using a hierarchical search interface similar to that described above in connection with a faceted search interface. However, it should be appreciated that a search wizard may use any type of user interface element to facilitate the specification of an agency claim by a user and embodiments of the invention are not limited in this respect.

Although only three types of user interfaces for specifying a query to be used for semantic searching have been described (i.e., Boolean search interface, faceted search interface, decision tree interface) it should be appreciated that other types of user interfaces for specifying an agency claim for performing semantic searching using a bias ontology are also included within the scope of this disclosure. For example, the search wizard illustrated in FIG. 12 is one exemplary type of decision tree interface and other types of decision tree interfaces are also contemplated.

As should be appreciated from the foregoing discussion of in-document covered action searches above, searches on covered documents, with the results displayed in-context within the document, involves a type of simplified semantic search. The simplification occurs because many of the search parameters are pre-selected. For example, since an agent creates a covered document on behalf of a principal, the agent and agent's covered action are already specified, and some of the remaining search information may be set to default values (e.g., search all covered interests). In addition, the format for displaying conflicts of interest may be set using stored configuration parameters or default values may be used. Accordingly, when a covered document is viewed using in-document alerts, the semantic search parameters and/or display parameters may not need to be separately specified when the covered document is viewed.

### An Exemplary Bias Ontology

As described above, social welfare often depends on the efficient division of labor, including the acquisition of specialized skills. The division of labor typically involves one entity paying another to perform a specialized task. The entity that delegates the task is the principal. And the entity that performs the task is the agent.

Principals often want to delegate tasks to trustworthy agents. Trustworthy agents typically have expertise to perform the required task and have interests in common with the principal. However, when an agent has a conflict of interest with the principal, the principal is less likely to trust the agent and may not delegate a task to the agent.

An agent's covered interests include financial interests that potentially have a bearing on the agent's covered actions. Covered actions include tasks an agent performs on behalf of the principal. An agency claim is a claim that an agent acts on behalf of a principal, backed by procedures to make that claim credible. The Applicant has recognized that agency claims are often embedded in laws and in written contracts, but they are rarely defined in well-structured, machine-readable terms. A bias ontology used by some embodiments of the invention to detect potential conflicts of interest provides a way to specify an agency claim in a machine-readable format. A result of a well-specified bias ontology is that a principal may access information relating to an agent's potential conflicts of interest in an efficient manner because the search for such information may be, at least partially, automated.

It should be appreciated that a bias ontology, like any other conflict of interest disclosure system, may not prove causality between a covered interest and a covered action, but only identifies correlations between an agent's covered interests and covered actions. For example, an interest group's contributions to an elected official may be associated with (e.g., by a political reporter) the official's vote on a bill affecting the interest group. However, although the existence of the contribution may give the appearance of a conflict of interest, the mere existence of the contribution does not prove a conflict of interest exists. Rather, the elected official may already be predisposed to support the interest group's cause and the interest group may merely be rewarding someone who already agrees with their position. Despite this potential limitation, automatic identification of potential conflicts of interest using a bias ontology may help increase the transparency between principals and agents and reduce the amount of time necessary to investigate such potential conflicts of interest.

An exemplary bias ontology for use with some embodiments of the invention includes a specification of (1) who specifies the agency claim and (2) the agency claim, where the agency claim includes (a) the principal, (b) the agent (c) the agent's covered interests, (d) the agent's covered actions, and (e) default settings linking the agent's covered interests and covered actions.

In some instances, a bias ontology may incorporate other ontologies to specify some or all of these components of an agency claim. For example, a bias ontology may specify an ID ontology to uniquely identify principals and agents and/or a financial ontology to specify an agent's covered interests and/or actions. A bias ontology may also be a subset of a larger ontology, such as a principal-agent ontology that includes, for example, a resume ontology that describes an agent's expertise to perform a given task.

Some components of an exemplary bias ontology for use with some embodiments of the invention is now described. A first component of the exemplary bias ontology indicates who specifies the agency claim. In the exemplary bias ontology described herein, there are no restrictions on the types of entities that may specify an agency claim, although for illustration purposes, at least three broad categories are defined: governments, agents, and third parties.

Many consumer protection laws may be characterized as agency relationships. Examples include the obligations of licensed doctors, real estate brokers, and financial advisors to act on behalf of their clients and disclose potential conflicts of interest. Similarly, laws concerning democracy often mandate that elected and other public officials act on behalf of a set of citizens and disclose potential conflicts of interest. In some instances, government agency claims may overlap. For example, different states and the federal government may all make agency claims about particular types of agents, such as a financial advisor.

Regardless of whether they are specifically regulated by the government, many providers of goods and services (i.e., agents) may make claims of independence to principals that may be characterized as agency claims. An individual elected representative, for example, may make claims about his independence from special interests that go well beyond what the law requires. Similarly, a media outlet that reviews products may issue a detailed set of ethical guidelines that promises to either ban or disclose certain types of conflicts of interest. At one extreme, these agency claims may be embodied in formal, written contracts with principals and thus have the force of law. At the other extreme, they may be little more than puffery. Many intermediate cases may also exist, such as when an agent belongs to a trade association with a written code of ethics, including a statement that agent members of the trade association will disclose to their principals all potential conflicts of interest.

Additionally, third-party watchdog groups often provide independent information and evaluations about principal-agent relationships. Such groups may combine agency data from government, agent, and/or other third party sources, seeking to provide the most accurate possible characterization of potential conflicts of interest between a principal and an agent. Some nonprofits, for example, supplement government-provided data about campaign contributions to political candidates with detailed information about the occupations of those making the contributions.

Often, one or more governments will set a minimum requirement for an agency claim, which the agent may elaborate upon. An independent watchdog, in turn, may incorporate the claims from both the government and the agent as a foundation for its own agency analysis, which may be supplemented by data it collects, such as observations by consumers, competitors, and inside whistle blowers.

In some cases, a third party may want to change rather than build upon an agency claim made by a government or agent. For example, the law might specify that the President and entire U.S. Senate are responsible for appointing commission members to federal agencies. However, if a third party knows that the president deferred to a particular powerful senator in selecting a particular nominee, the third party might specify in an agency claim that the interests of the president and other senators were immaterial to the selection of the nominee.

In the exemplary bias ontology described herein, each principal within the bias ontology may be identified using a unique ID, which, as described above, may be based on an ID ontology used to describe individual or corporate entities. Each principal in the bias ontology may be an individual principal (e.g., a citizen in a political district) or a group of individuals (e.g., all citizens in a political district), also called a “corporate principal.” With a corporate principal, the task of specifying agency claims may be simplified in cases where many principals belong to a single class of principals, such as “shareholders” who are represented by a corporate board of directors, “constituents” who are represented by elected representatives, and “readers” who patronize a consumer magazine.

Additionally, each agent within the exemplary bias ontology may be identified using a unique ID, which may be based on an ID ontology used to describe individual or corporate entities. Each agent may be an individual agent (e.g., an elected official) or a group of individuals (e.g. a legislature made up of elected officials), also called a “corporate agent.” In accordance with some embodiments of the invention, a conflict of interest search on a corporate agent may aggregate all the potential material conflicts of interests of the individual agents that constitute it. For example, if the agent is a city council and the covered action for the city council is a vote to approve its annual budget, then the covered interests of each of the members of the city council may be associated with the respective budget line items during the covered action search. In contrast, if the agent is a specific member of the city council and the covered action of the member is his particular vote to approve the city's annual budget, then only the covered interests of the specific member may be associated with the respective budget line items during a covered action search.

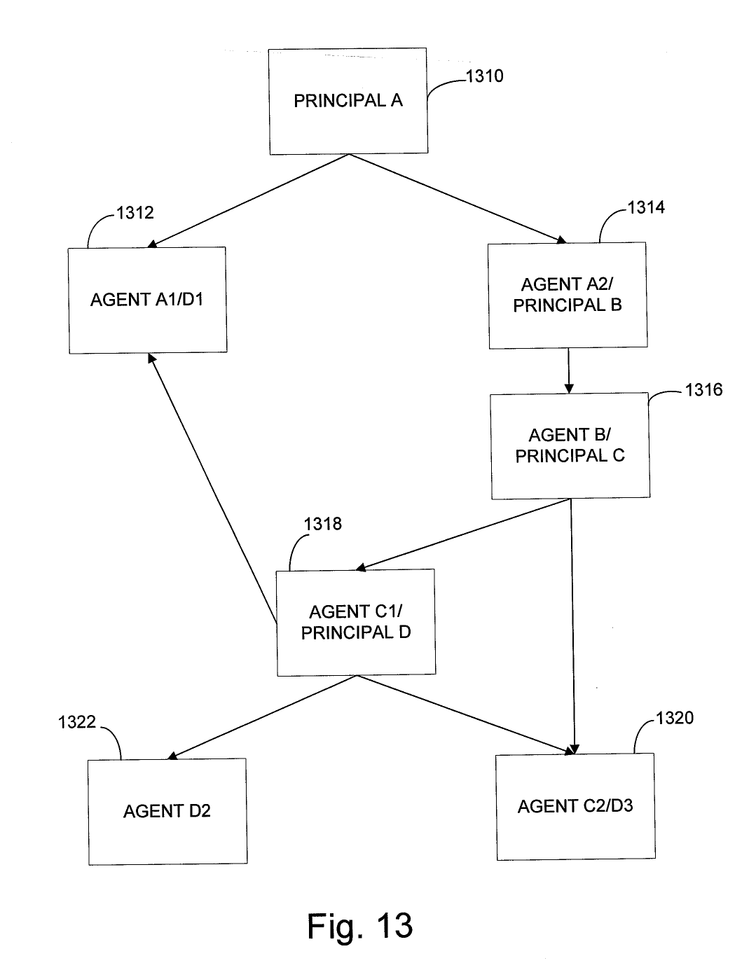

Principals may have multiple agents, agents may have multiple principals, and these principals and agents may be nested together in complex hierarchies. A member of Congress, for example, may be an agent for his constituents and a principal of Congress as a whole, one or more standing committees and subcommittees within Congress, one or more ad hoc committees within Congress, and a political party organization within Congress. An example of a hierarchical principal-agent structure is illustrated in FIG. 13.

In the exemplary hierarchical structure of FIG. 13, principal 1310 has two separate agency relationships with agents 1312 and 1314, respectively. However, agent 1314 is also a principal in an agency relationship with agent 1316. Agent 1316 is also a principal in separate agency relationships with agents 1318 and 1320. Additionally, agent 1318 is also a principal in separate agency relationships with agents 1312, 1320, and 1322. Thus, as should be appreciated from the foregoing, some principals may have multiple agents (e.g., principal 1318 has three agents), and some agents may have multiple principals (e.g., agent 1312 has two principals). By describing each of the agency relationships using a bias ontology, an identification of potential conflicts of interests between principals and agents within such a hierarchy may be simplified.

Additionally, even though principals and agents may not have a direct agency relationship (e.g., principal 1310 and agent 1312), some potential conflicts of interest involving indirect (e.g., secondary, tertiary, etc.) agency relationships between principals and agents may also be identified. For example, even though agent 1316 does not have a direct agency relationship with principal 1310, agent 1316 has an indirect agency relationship with principal 1310 via principal 1314 which is both a principal of agent 316 and an agent of principal 1310.

The exemplary bias ontology described herein identifies the covered interests of an agent. Standard systems of financial reporting for assets and income may serve as the basis for such a description of an agent's covered interests. For example, the eXtensible Business Reporting Language (XBRL), is an open, standardized, well-structured, machine-readable, financial ontology that is being adopted for the public reporting of financial information for large, public companies. It is also widely expected that XBRL will be widely adopted for other types of financial reporting and be integrated into popular accounting packages. XBRL is extensible and could thus serve as the basis for describing potential financial conflicts in the context of a principal-agent relationship.

The SEC's implementation of XBRL, based on Generally Accepted Accounting Principles (GAAP), currently has more than 14,000 tags to describe financial data. However, the language is extensible and additional tags can be added as needed. Tags in XBRL are hierarchically structured to correspond to the logic of standard financial statements such as income and balance statements. For example, there may be tags to describe the general category of net income and tags to describe subcategories of net income such as revenue and expenses. Similarly, there may be tags to describe the assets and liabilities on a balance sheet, with assets divided into subcategories such as current and long-term assets.

Financial statements for an agent may be divided into separate accounts. For example, an elected official's financial statements may be divided into separate accounts for running a Congressional office and for running a Congressional campaign, and a doctor's financial statements may be divided into separate accounts for the doctor's medical practice and for the doctor's tourism business. However, because the bias ontology associates each of the separate accounts with the same entity, the separate accounts can also be aggregated, if desired.

An exemplary bias ontology may also include a tag directed to whether the source of revenue is principal income or non-principal income. For example, for an elected representative of the public, salary and benefits paid for by the government may be considered principal income whereas money donated by campaign contributors may be considered non-principal or “outside” income. The Applicant has recognized that conventional financial ontology systems tend to use different and incompatible sets of accounts for principal and non-principal income. For example, salary and benefits paid to elected officials by a government may be in an entirely separate set of accounts from campaign contributions and gifts to elected officials. Future extensions to financial ontologies such as XBRL may allow such sets of accounts to be seamlessly integrated and searched using a bias ontology.

Some types of revenue may be prohibited and these types of revenue may be captured by the exemplary bias ontology. For example, campaign contributions to members of Congress from foreign governments or government contracts from agencies overseen by members of a public body may be prohibited. Other types of revenue, such as campaign contributions to candidates for a legislature, may be prohibited, but only when the contributions exceed a certain limit (e.g., $5,000 per contributor).

Different types of public disclosure rules may accompany different types of income and assets. For example, disclosure of financial interests may be required only when an agent performs a specific covered action, or alternatively, all covered financial interests of an agent may be fully searchable by the public. Additionally, some agents may only want to disclose certain conflicts of interests while withholding others. For example, media may want to exclude advertising from conflict of interest disclosures to readers but want to include gifts to reporters.

As described above, which covered interests are made available for a semantic search may depend on the type of entity. Governments and government officials, for example, may be obliged to make all covered interests publicly available, whereas businesses may be allowed to keep some detailed data about their interests as a trade secret. That is, some businesses may keep some interests as a trade secret until disclosure of the interests has been triggered by one or more covered actions.

The terms of disclosure for the same agency relationship may also differ based on who is compiling the data for an agency claim. For example, governments and agents may seek less disclosure about information about interests than third parties.

Information about a threshold for a conflict of interest to be material and thus disclosed may also be captured by a tag in an exemplary bias ontology. For example, elected officials may only be required to disclose gifts worth more than $25, and the threshold may be set accordingly. Additionally, an exemplary bias ontology may include government and non-government sub-classes of the threshold tag field. For example, the government may set the threshold at $25, but a user may consider that only gifts above $100 are material. For a consumer magazine, there might be a different type of threshold. For example, only advertisers that represent more than 1% of total advertising revenue might be disclosed.

XBRL or another financial ontology may be extended to include a standard ontology of corporate and individual vendors. Such an extension may enable the transactions with the same vendor within and across financial databases to be identified and analyzed.

Linked to a vendor ID might be other information. For example, for an organizational entity, the GPS coordinates of the vendor's real estate property and/or the Standard Industrial Classification (SIC) codes identified with the vendor's industry may be included. For an individual entity, the GPS coordinates of the individual's real estate property as well as any occupational licenses the individual possesses may be included among other things.

Additional tags for in-kind income and personal assets may also be included in an exemplary bias ontology. Subsidized travel, for example, is often an important type of in-kind gift to elected officials, and an occupational license may be a valuable asset possessed by an elected official that wouldn't ordinarily be included and tagged on a statement of financial assets.

For conflict of interest reporting, certain types of unearned income may also be reported. For example, if a real estate broker has made a formal offer on a house on behalf of a client from which the broker will earn a 6% commission if the sale is completed, this information may be automatically tagged as a financial interest. Subsequently, if the broker makes a bid on the same house for a second client, both clients may be automatically notified that the broker has a conflict of interest because simultaneously negotiating for the same house on behalf of two different clients puts those clients' interests in conflict.

XBRL or another covered interest ontology may also be extended to include nepotistic relationships as a type of asset. For example, spouses, parents, and children may all be viewed as a type of asset.

Agents may undertake certain formal actions on behalf of principals. Executive branch elected representatives, for example, may create budget documents, vote on bills, appoint commissioners, and regulate private property, such as grant building permits. Similarly, doctors may refer patients to other doctors, prescribe drugs for patients, and recommend that patients purchase certain medical devices. As with covered interests, each of these official actions may be specified by one or more ontologies. For example, ontologies for budget documents, legislative documents, and doctor referrals may be used. An exemplary bias ontology may add tags to these ontologies to identify the beneficiaries of covered actions and facilitate the automatic linkage between covered interests and covered actions.

For example, a doctor's prescription for a patient may be automatically linked to gifts the doctor received from an agent representing the pharmaceutical manufacturer; a blogger's review of a product may be automatically linked to free product samples or other compensation received from an agent representing the product's manufacturer; and a legislator's earmark requests (e.g., members of the U.S. House of Representatives are required to list their earmark requests on their home pages) may be automatically linked to campaign contributors.

Where current disclosures of covered actions do not facilitate the clear disclosure of beneficiaries, those disclosures and related databases may be modified to facilitate such disclosure. For example, bills proposing local zoning changes may be linked to the local land use office, thereby linking the beneficiaries of the proposed changes to specific plots of land. Similarly, many legislatures require an independent legislative research service to estimate the net cost of bills. When these legislative services identify a tax expenditure narrowly targeted to a company, industry, or region, the estimate may be tagged to include this information. For example, a simple rule may be employed so that when the beneficiaries of a proposed tax expenditure are narrowly targeted, such as when more than 50% of the benefit of a federal tax expenditure goes to less than 0.1% of taxpayers or fewer than 1,000 companies, then the specific beneficiaries of the proposed tax expenditure must be identified.

Where beneficiaries are hard to identify and link to interests, conflict of interest disclosure may be supplemented by manually entered conflict of interest meta data in covered documents. For example, many newspaper writers include personal conflict of interest disclosure statements when they cover certain subjects, including products, places, and things. These can be tagged as relevant disclosure data within a covered document, with the reader being given control over how these disclosures appear in the text, as described above with respect to in-document alerts. Since the reader may be given control over how the disclosures appear, the author of the article may add all relevant disclosures to the document without fear that excessive disclosure will make the article unreadable.

An agency claim in a bias ontology may include default settings specifying the linkages between covered interests and covered actions. For example, many laws mandate the disclosure of some but not other interests associated with a covered action. The Federal Communications Commission (FCC), for example, mandates that lobbyists filing ex parte disclosures of their FCC lobbying activities include a list of their FCC licenses in their disclosures. This privileged set of interests associated with a covered action—in this case, FCC licenses automatically linked to an ex parte filing—may be specified in the agency claim.

Default settings may be preset for certain classes of agents and covered actions or only for a particular agent and covered action. Many conflict of interest rules, for example, specify that an agent self report potentially material conflicts of interest with respect to a particular covered interest. This type of self disclosure may work especially well when the penalty for omitting a material disclosure is large. For example, as a precondition of publication, many medical and scientific journals require authors to sign a statement self reporting their potentially material conflicts of interest. The penalty for omitting a material conflict of interest may be being blacklisted from future publication—a severe penalty for an academic. Similarly, Congress may require witnesses to disclose potentially material conflicts of interest and subject them to perjury charges for material omissions.

In some cases, such as a blogger-agent revealing a conflict of interest when a specific product is reviewed, there may be only one or a few results from a bias check and thus little need to rank the results. However, when a bias check generates many linkages between covered interests and actions, ranking the results for prioritized display may be desirable. Any suitable ranking technique may be used to rank the results of a search. One ranking technique may rank order results of a bias check based, at least in part, on categories. For example, the covered interests may be divided into categories and the linkages between covered interests and covered actions may be displayed according to those categories. For example, the results may be ranked and displayed according to any combination of categories, such as: (a) government vs. non-government mandated covered interest disclosures, (b) degree of principal-agent separation in a hierarchy of principal-agent relationships, (c) personal vs. institutional covered interests (e.g., where a politician's personal assets are a personal covered interest and campaign contributions an institutional covered interest), and (d) monetary income vs. in-kind income.

Alternatively, linkages between covered interests and covered actions may be analyzed using one or more statistical techniques such as regression. Various categories of interests may then be rank ordered according to their statistical significance and power explaining agent actions. For example, a regression analysis may determine the likelihood of a newspaper-agent mentioning a regular advertiser in its news stories, with regular advertisers divided into categories such as local vs. national. Categories of advertisers most likely to receive news coverage may be given prioritized display. It should be noted, however, that drawing these automatic correlations may not be adequate to infer their meaning. For example, one might expect that non-advertisers are most frequently cited negatively and advertisers most frequently cited positively. In some instances, this additional level of categorization may be performed manually. Still, a large amount of the work necessary to perform such analyses could be automated using one or more of the techniques described above.

Exemplary bias ontologies for use with some embodiments of the invention may be simple or complex provided that the core logical constructs of principal, agent, covered interest, and covered action are included. For example, consider a conflict of interest search for a legislator. A simple bias ontology may only include campaign contributions for a covered interest and earmarks for a covered action. Alternatively, a more complex bias ontology may include all of a legislator's financial interests and all of the legislator's formal, public actions on behalf of constituents. The efficiency gains in search from using a simple versus a complex bias ontology and accompanying agency claim may differ. For example, where the bias ontology and agency claim cover more interests and actions, the efficiency gains are expected to be greater.

Table 1 illustrates a set of tags that may be included in an exemplary bias ontology that may be used with some embodiments of the invention. As should be appreciated from the foregoing discussion, a bias ontology is preferably extensible and may include some or all of the tags listed in Table 1. A bias ontology may additionally include other tags to describe various aspects of an agency relationship and/or tags to facilitate the display of conflict of interest search results in accordance with the architectures and interfaces described above in connection with some embodiments of the invention.

The Applicant has recognized that determining the quality of data provided in an agency claim may be important in assessing the validity of the information in the agency claim. However, governments and agents may not have the resources or incentive to police the quality of data included in agency claims. The use of third party reviews of the data may be useful way to address such problems. Governments frequently solicit such commentary via telephone hotlines, formal, written complaint processes, and other methods where the public accessibility of the third party reviews is often difficult. The resulting commentary is often ignored or otherwise not used to adjust an agency claim, even when the commentary provides valuable information on the validity of the agency claim. To improve the quality reporting of data in agency claims, a bias ontology for use with some embodiments of the invention may associate one or more of the tags of the bias ontology with a third party review tag or pointer associated with the tag. Accordingly, government agency claims may be integrated with private sector reviews about their validity and reliability.

In one implementation incorporating third party review tags, whenever an agency claim is searched for, the user may have the option to link some or all of the third party commentary on the quality of the data contained in the agency claim. Depending on the user's preferences, this commentary may be aggregated across the entire agency claim and/or presented at the level of each line item associated with the bias ontology—e.g., the detailed covered interests and covered actions. An extension to the interfaces described above may include, for example, a footnote or other maker that, when selected, opens up a window to all relevant information on the quality of the information in the bias ontology.

TABLE 1
Exemplary tags for an exemplary bias ontology

WhoSpecifiesTheAgencyClaim (government, agent, other)
TypeOfPrincipalUniqueID
PrincipalUniqueID
PrincipalName
IndividualOrAggregatePrincipal (individual agent, corporate agent).
TypeOfAgentUniqueID
AgentUniqueID
AgentName
IndividualOrAggregateAgent (e.g., individual agent, corporate agent)
PrincipalOrNonPrincipalIncome
SubclassOfNonPrincipalIncome: BannedorNotBannedIncome
SubclassOfNonPrincipalIncome: BannedIncomeThreshold
SubclassOfNonPrincipalIncome: TypeOfDisclosure
SubclassOfNonPrincipalIncome: MaterialityThreshold
TypeOfVendorID

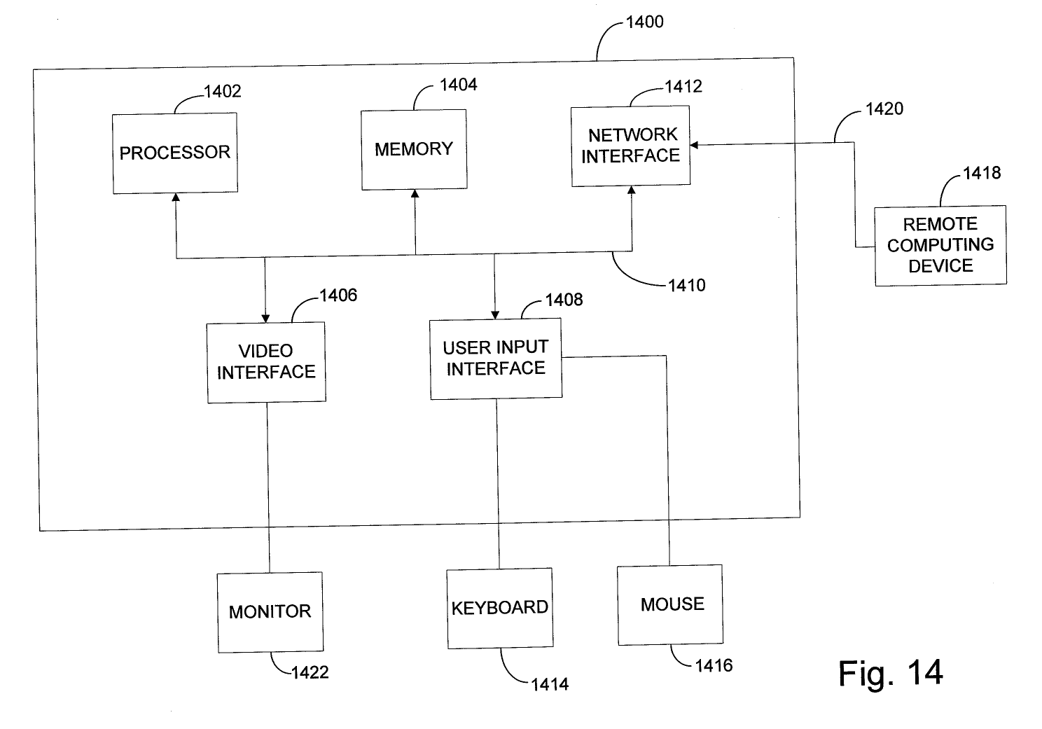

FIG. 14 shows a schematic block diagram of an illustrative computer 1400 on which aspects of the invention may be implemented. Only illustrative portions of the computer 1400 are identified for purposes of clarity and not to limit aspects of the invention in any way. For example, the computer 1400 may include one or more additional volatile or non-volatile memories, one or more additional processors, any other user input devices, and any suitable software or other instructions that may be executed by the computer 1400 so as to perform the function described herein.

In the illustrative embodiment, the computer 1400 includes a system bus 1410, to allow communication between a central processing unit 1402, a memory 1404, a video interface 1406, a user input interface 1408, and a network interface 1412. The network interface 1412 may be connected via network connection 1420 to at least one remote computing device 1418. Peripherals such as a monitor 1422, a keyboard 1414, and a mouse 1416, in addition to other user input/output devices may also be included in the computer system, as the invention is not limited in this respect.

In some embodiments, one or more techniques for performing a covered action search and/or a semantic search as disclosed herein may be performed by one or more processors included in the same or different computer including, but not limited to, computer 1400. For example, the method illustrated in FIG. 1 for performing a covered action search may be executed on a different processor than the technique illustrated in FIG. 4 for performing a semantic search on data stored in accordance with a bias ontology. Additionally, in embodiments where multiple processors are used, the results of one technique performed by a first processor may be transmitted to a second processor to perform a second technique in any suitable way including, but not limited to, transmitting the results across a wired or wireless network, storing the results in a shared database, and physically transferring the results to a second computer on a tangible computer-readable medium.

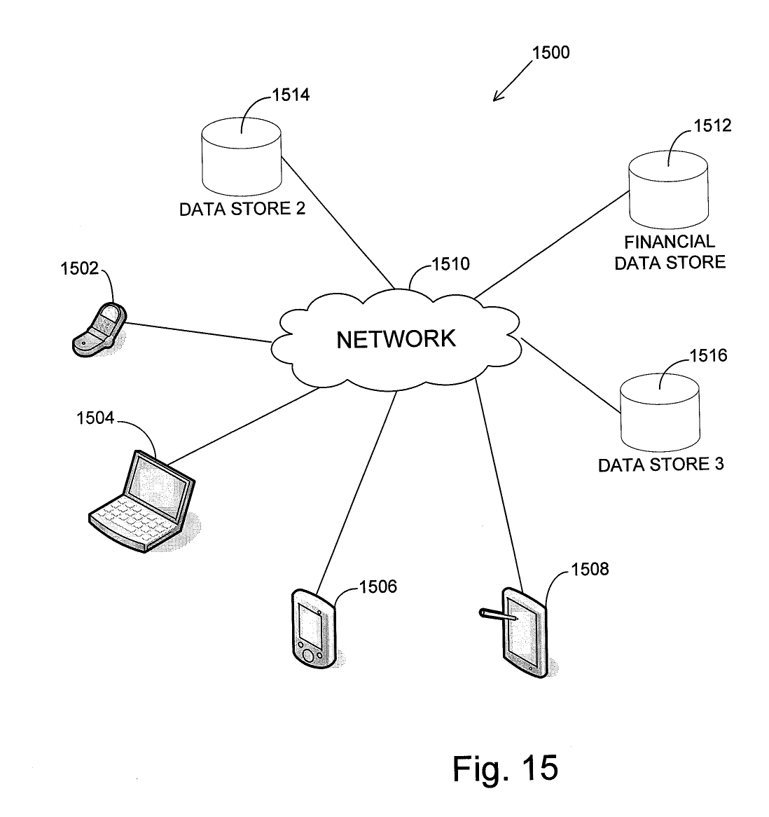

Some embodiments may be used in connection with at least one networked computer system such as the computer system 1500 illustrated in FIG. 15. The computer system 1500 comprises a plurality of computing devices including, but not limited to cellular phone 1502, laptop 1504, PDA 1506, and tablet computer 1508. Each of these computing devices is connected to a plurality of data sets via network 1510 using one or more wired or wireless connections. For example, network 1510 may be the Internet and each of the computing devices may comprise software and/or hardware configured to access the Internet using one or more wired or wireless connections. The computer system 1500 may include a plurality of data stores accessible to network 1510 and configured to store data sets comprising disclosure data stored in accordance with a bias ontology as described herein. In some embodiments, the plurality of data stores includes at least one financial data store 1512 configured to store financial information for a plurality of agents in an agency relationship. The plurality of data stores may also include data stores (e.g., data store 1514 and data store 1516) configured to store other information related to potential conflict of interest reporting. Embodiments are not limited by the number of data stores and computing devices in computer system 1500. For example, in some embodiments, all computing devices and data stores connected to the Internet may be considered as part of computer system 1500.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of identifying one or more conflicts of interest between a principal and an agent, the method comprising:
determining that the agent has performed a covered action on behalf of the principal;
determining an existence of at least one covered interest for the agent;
associating, with at least one processor, the at least one covered interest with the covered action if it is determined that the at least one covered interest exists.

2. The method of claim 1, further comprising:
outputting, an indication that the at least one covered interest represents a potential conflict of interest between the principal and the agent.

3. The method of claim 2, wherein the indication comprises an out-of-document alert that is provided to a user in a notification separate from a document displayed to the user.

4. The method of claim 3, further comprising:
providing the out-of-document alert to the user in response to detecting an occurrence of the covered action.

5. The method of claim 3, further comprising:
providing the out-of-document alert to the user at a specified time and/or at periodic time intervals.

6. The method of claim 2, wherein the indication comprises an in-document alert embedded in a document displayed to a user.

7. The method of claim 6, wherein the in-document alert comprises at least one visual indication of the potential conflict of interest.

8. The method of claim 7, wherein the at least one visual indication comprises highlighting at least one link in the document to indicate the potential conflict of interest.

9. The method of claim 6, wherein associating the at least one covered interest for the agent with the covered action is performed in response to displaying the document to the user.

10. The method of claim 2, wherein the indication is output in accordance with at least one configuration parameter selected by a user.

11. The method of claim 2, wherein the indication comprises conflict of interest information for a plurality of agents and/or a plurality of covered actions.

12. The method of claim 2, further comprising:
associating with the indication, third party commentary related to a quality of the data in the indication.

13. The method of claim 12, wherein the indication comprises at least some of the third party commentary.

14. A method of identifying one or more potential conflicts of interest between a principal and an agent, the method comprising:
receiving at least one query to identify the one or more potential conflicts of interest;
aggregating, with at least one processor, information from a plurality of data sets based, at least in part, on information in the at least one query and metadata associated with the information in the plurality of data sets; and
outputting an indication of the aggregated information, wherein the indication represents the one or more potential conflicts of interest between the principal and the agent.

15. The method of claim 14, wherein the at least one query specifies an identifier for the principal, an identifier for the agent, at least one covered action, at least one covered interest, and/or a date range used to select information from the plurality of data sets.

16. The method of claim 14, wherein the agent is a corporate agent comprising a first plurality of individuals and/or the principal is a corporate principal comprising a second plurality of individuals.

17. The method of claim 15, wherein the metadata associated with the information in the plurality of data sets identifies at least one principal-agent relationship.

18. The method of claim 17, wherein the at least one principal-agent relationship is specified by one or more tags associated with the information in the plurality of data sets.

19. The method of claim 14, wherein aggregating information from the plurality of data sets comprises associating at least one covered interest for the agent with at least one covered action for the agent.

20. The method of claim 14, further comprising:
receiving conflict of interest metadata manually entered by an author of a document; and
wherein the indication of aggregated information is output based, at least in part, on the manually entered metadata.

21. The method of claim 14, further comprising:
displaying at least one search interface to a user, wherein the at least one search interface comprises one or more fields configured to enable the user to specify information for the at least one query; and
generating the at least one query based, at least in part, on the information specified by the user in the at least one search interface.

22. The method of claim 21, wherein the at least one search interface comprises a Boolean interface.

23. The method of claim 21, wherein the at least one search interface comprises a faceted search interface.

24. The method of claim 21, wherein the faceted search interface comprises a decision tree interface.

25. A computer-readable storage medium encoded with a plurality of instructions that, when executed by a computer, perform a method comprising:
determining that the agent has performed a covered action on behalf of the principal;
determining an existence of at least one covered interest for the agent;
associating the at least one covered interest with the covered action if it is determined that the at least one covered interest exists.

26. A computer system comprising:
at least one processor programmed to:
receive at least one query to identify the one or more potential conflicts of interest;
aggregate, with the at least one processor, information from a plurality of data sets based, at least in part, on information in the at least one query and metadata associated with the information in the plurality of data sets; and
output an indication of the aggregated information, wherein the indication represents the one or more potential conflicts of interest between the principal and the agent.
